(19) United States
(12) Patent Application Publication
(10) Pub. No.: US 2012/0090865 A1
(43) Pub. Date: Apr. 19, 2012

(54) Method of manufacturing porous ultraviolet curable resin coated wire, porous ultraviolet curable resin coated wire and coaxial cable

(75) Inventors: Yoshihisa Kato, Takahagi (JP); Osamu Seya, Hitachi (JP); Detian Huang, Hitachi (JP)

(73) Assignees: Hitachi Cable Fine-Tech, Ltd., Hitachi-shi (JP); HITACHI CABLE, LTD., Tokyo (JP)

(21) Appl. No.: 13/067,089

(22) Filed: May 6, 2011

(30) Foreign Application Priority Data
Oct. 14, 2010 (JP) 2010-231545

(51) Int. Cl. H01B 11/06; B05D 5/12; B32B 3/26

(52) U.S. Cl. 174/34; 428/304.4; 427/118

(57) ABSTRACT

A method of manufacturing a porous ultraviolet curable resin coated wire includes (a) preparing an ultraviolet curable resin composition not including a hydrous water absorbent polymer, (b) preparing a hydrous water absorbent polymer-dispersed ultraviolet curable resin composition having a water content of 40% or more by preparing a water-swollen hydrous water absorbent polymer including a water absorbent polymer and water, and then dispersing the hydrous water absorbent polymer into the ultraviolet curable resin composition, (c) forming a two-layer structure on a metal wire by coating the metal wire with the ultraviolet curable resin composition not including the hydrous water absorbent polymer and the hydrous water absorbent polymer, and (d) performing a dehydration on the two-layer structure.

The present application is based on Japanese Patent Application No. 2010-231545 filed on Oct. 14, 2010, the entire contents of which are incorporated herein by reference.

### BACKGROUND OF THE INVENTION

1. Field of the Invention

The invention relates to a method of manufacturing a porous ultraviolet curable resin coated wire using a hydrous water absorbent polymer-dispersed ultraviolet curable resin composition, a porous ultraviolet curable resin coated wire and a coaxial cable.

2. Related Art

In recent years, in accordance with downsizing or high-density mounting of precision electronic devices or communication devices in medical and other fields, a diameter of a wire/cable used for those devices is more and more reduced. Furthermore, the trend of further high-speed transmission signal is remarkable for a signal line, etc., and it is desired to speed up the transmission signal by thinning an insulating layer of a wire used therefor and decreasing dielectric constant as much as possible.

A foamed insulating material having low dielectric constant such as a polyethylene or fluorine resin is used for the conventional insulating layer of wire. A method in which a pre-foamed film is wound around a conductor or an extrusion method in which a molten foam insulation material is extruded to cover a conductor are known for forming the foamed insulation layer, and especially the extrusion method is widely used.

A foam forming method is roughly classified into two types, one of which is a physical foaming method and another of which is a chemical foaming method. The physical foaming method includes a method in which a volatile foaming liquid such as liquefied chlorofluorocarbon is injected into a molten resin to make foams by the vaporization pressure, or a method in which a foaming gas such as nitrogen gas or carbon dioxide gas is directly injected into a molten resin in an extruder to generate uniformly-distributed cellular fine independent foam body in the molten resin.

On the other hand, the chemical foaming method includes a method in which an foaming agent is mixed dispersed in the molten resin and is molded and subsequently heated to generate a decomposition reaction of the foaming agent, and foams are produced by using gas generated by the decomposition.

A thin-coating method alternative to the above-mentioned extrusion method includes coating methods such as thermosetting resin coating as typified by an enameled wire or ultraviolet curable resin coating of optical fiber.

For example, related arts to the invention may be JP-A-58-62024, JP-A-57-170725, JP-A-3-185063, JP-A-11-5863, JP-A-11-100457 and JP-B-3717942.

### SUMMARY OF THE INVENTION

In the physical foaming method of injecting the volatile foaming liquid into the molten resin, the vaporization pressure is high and fine formation or uniform formation of foams is difficult, thus, there is a limit to thin formation. In addition, since the injection speed of the volatile foaming liquid is slow, there is a problem such that it is difficult to increase the production speed and the productivity is poor.

In the physical foaming method of directly injecting the foam-forming gas in the extruder, since there is a limit to diameter or thickness reduction in thin extrusion and a special facility or technology is required for safety, there is a problem that the productivity is poor and the production cost rises significantly.

There are problems that environmental load of the physical foaming method using chlorofluorocarbon, butane and carbon dioxide gases etc., is high and that the foaming agent used for the chemical foaming is expensive.

On the other hand, in the chemical foaming method, the foaming agent is preliminarily kneaded and mixed dispersed in the molten resin and is then foamed by a gas which is generated by reacting and decomposing the foaming agent by heat after the molding process. Therefore, there is a problem that the molding process temperature of the molten resin needs to be kept lower than the decomposition temperature of the foaming agent. Furthermore, when a diameter of wire is small, there is another problem in an extrusion coating such that the wire breakage is likely to occur due to resin pressure and it is thus difficult to increase speed.

Meanwhile, in the coating method using a liquid material such as thermosetting resin or ultraviolet curable resin which is effective for thin coating and when a thermosetting resin is used, a large proportion of the material is a solvent and coating formation is carried out by volatilizing the solvent and baking, thus, a film thickness obtained by a single coating is several μm or less, which requires multilayer coating, and it is difficult to form a foam layer (porous layer). Meanwhile, in case of a twisted conductor, there is a problem that a solvent enters a gap between the conductors, which makes the solvent difficult to volatilize, and swelling of coating is likely to occur. Furthermore, there is a problem that the environmental load is high due to the use of solvent.

An ultraviolet curable resin is easy to render solvent-free and useful for high-speed thin coating, however, there is a problem that many of them are poor in flexibility and thermal shock which are essential for coating of a wire/cable, and breakage (crack) is likely to occur when being bent such as a case of self-wrapping.

An alternative method has been suggested in which a hydrous water absorbent polymer prepared by swelling a water absorbent polymer with water is dispersed in a liquid cross-linked curable resin and dehydration is performed after curing to form a porous layer. This method is excellent because it is easy to speed up the coating and the environmental load is small, however, there is a problem that outer diameter variation is likely to occur due to a decrease in wettability when the dispersed amount of hydrous water absorbent polymer is increased, and the coating quality significantly decreases.

It is an object of the invention to provide a method of manufacturing a porous ultraviolet curable resin coated wire using a porous thin film allowing diameter and thickness reduction as a formation material, a porous ultraviolet curable resin coated wire and a coaxial cable.

(1) According to one embodiment of the invention, a method of manufacturing a porous ultraviolet curable resin coated wire comprises:

preparing an ultraviolet curable resin composition not including a hydrous water absorbent polymer;

preparing a hydrous water absorbent polymer-dispersed ultraviolet curable resin composition having a water content of 40% or more by preparing a water-swollen hydrous water absorbent polymer comprising a water absorbent polymer and water, and then dispersing the hydrous water absorbent polymer into the ultraviolet curable resin composition;

forming a two-layer structure on a metal wire by coating the metal wire with the ultraviolet curable resin composition not including the hydrous water absorbent polymer and the hydrous water absorbent polymer-dispersed ultraviolet curable resin composition; and

performing a dehydration on the two-layer structure.

In the above embodiment (1) of the invention, the following modifications and changes can be made.

(i) The two-layer structure is formed by coating and curing the ultraviolet curable resin composition not including the hydrous water absorbent polymer on the metal wire, and then coating the hydrous water absorbent polymer-dispersed ultraviolet curable resin composition on the ultraviolet curable resin composition.

(ii) The two-layer structure is formed by simultaneously coating on the metal wire the ultraviolet curable resin composition not including the hydrous water absorbent polymer and the hydrous water absorbent polymer-dispersed ultraviolet curable resin composition.

(iii) A relation of A<B is established where A represents a viscosity of the hydrous water absorbent polymer-dispersed ultraviolet curable resin composition and B represents a viscosity of the ultraviolet curable resin composition not including the hydrous water absorbent polymer.

(2) According to another embodiment of the invention, a porous ultraviolet curable resin coated wire comprises:

a metal wire;

a skin layer on the metal wire; and

a porous layer on the skin layer,

wherein the skin layer comprises an ultraviolet curable resin composition not including a hydrous water absorbent polymer, and

the porous layer comprises a hydrous water absorbent polymer-dispersed ultraviolet curable resin composition having a water content of 40% or more formed by preparing a water-swollen hydrous water absorbent polymer comprising a water absorbent polymer and water, and then dispersing the hydrous water absorbent polymer into the ultraviolet curable resin composition.

In the above embodiment (2) of the invention, the following modifications and changes can be made.

(iv) The porous layer comprises a porous ultraviolet curable resin that is obtained by curing the hydrous water absorbent polymer-dispersed ultraviolet curable resin composition and then performing a thermal dehydration on the hydrous water absorbent polymer-dispersed ultraviolet curable resin composition.

(v) The skin layer has a thickness of not less than 1 μm and not more than 10 μm.

(3) According to another embodiment of the invention, a coaxial cable comprises:

the porous ultraviolet curable resin coated wire according to the embodiment (2); and

a shielding body comprising a metal and formed on outer periphery of the porous ultraviolet curable resin coated wire.

Points of the Invention

According to one embodiment of the invention, a method of manufacturing a porous ultraviolet curable resin coated wire is carried out such that a coated wire has a two-layer structure that a skin layer including an ultraviolet curable resin composition not including a hydrous water absorbent polymer and a porous layer including a hydrous water absorbent polymer-dispersed ultraviolet curable resin composition are sequentially formed on an outer periphery of a metal conductor. The reason for the skin layer formed on the metal conductor is because the wettability and the interfacial tension can be enhanced in coating the hydrous water absorbent polymer-dispersed ultraviolet curable resin composition on the skin layer. Therefore, a stable coating layer with no coating unevenness can be formed on the metal conductor. Especially, when the water content of the hydrous water absorbent polymer-dispersed ultraviolet curable resin composition is 40% or more, the composition may cause a decrease in wettability with the metal conductor.

### BRIEF DESCRIPTION OF THE DRAWINGS

Next, the present invention will be explained in more detail in conjunction with appended drawings, wherein:

FIG. 1 is a horizontal cross sectional view schematically showing a porous film coated wire in a typical embodiment of the present invention;

FIG. 2 is a horizontal cross sectional view schematically showing a coaxial cable using a porous ultraviolet curable resin coated wire of the invention;

FIG. 3 is a horizontal cross sectional view schematically showing another example of a coaxial cable using the porous ultraviolet curable resin coated wire of the invention;

FIG. 4 is a photograph of external appearance of a porous ultraviolet curable resin coated wire in a typical Example of the invention;

FIG. 5 is a photograph of external appearance of a porous ultraviolet curable resin coated wire in Comparative Example 1; and

FIG. 6 is a cross sectional photograph of a porous ultraviolet curable resin coated wire in a typical Example of the invention.

### DESCRIPTION OF THE PREFERRED EMBODIMENTS

A preferred embodiment of the invention will be specifically described below with reference to the appended drawings.

Structure of Coated Wire

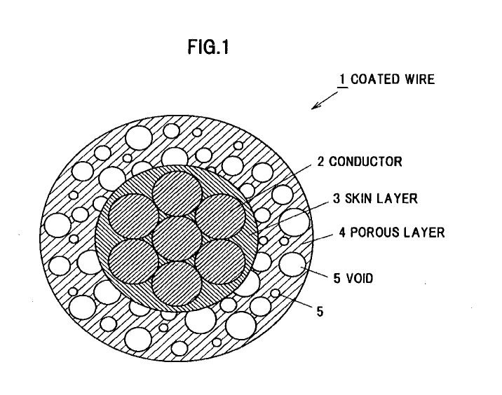

In FIG. 1, the reference numeral 1 indicating the entire coated wire schematically shows one example of a coated wire using a hydrous water absorbent polymer-dispersed ultraviolet curable resin composition. The coated wire 1, which is a porous ultraviolet curable resin coated wire, is mainly composed of a conductor 2 which is a twisted wire formed of metal such as copper, a skin layer 3 formed to cover an outer periphery of the conductor 2 and a porous layer 4 formed to cover an outer periphery of the skin layer 3.

The skin layer 3 is formed of an ultraviolet curable resin composition not including a hydrous water absorbent polymer. Meanwhile, the porous layer 4 is formed of a hydrous water absorbent polymer-dispersed ultraviolet curable resin composition and is configured as a porous layer in which the skin layer 3 provided on the outer periphery of the conductor 2 is further coated with the ultraviolet curable resin composition and cured and water in the hydrous water absorbent polymer is subsequently removed by heating the cured resin composition to form plural voids 5 in the resin composition.

The coated wire 1 in the present embodiment is characterized in having a two-layer structure in which the skin layer 3 formed of an ultraviolet curable resin composition not including the hydrous water absorbent polymer and the porous layer 4 formed of a hydrous water absorbent polymer-dispersed ultraviolet curable resin composition are formed to cover the outer periphery of the conductor 2. The coating layers of the two-layer structure may be formed by applying and curing the skin layer 3 on the outer periphery of the conductor 2 and subsequently coating the outer periphery of the skin layer 3 with the porous layer 4, or may be formed by coating the outer periphery of the conductor 2 with the skin layer 3 and the porous layer 4 at the same time.

The thickness of the skin layer 3 is set to within a range of not less than 1 μm and not more than 10 μm. A relation between a viscosity A of the hydrous water absorbent polymer-dispersed ultraviolet curable resin composition used for the porous layer 4 and a viscosity B of the ultraviolet curable resin composition used for the skin layer 3 is the viscosity A<the viscosity B. A porosity of the porous layer 4 is not specifically limited, but is set to be not less than 50% and not more than 70%.

The skin layer 3 is provided on the metal conductor 2 to form a stable coating layer with no coating unevenness by enhancing the wettability for coating the hydrous water absorbent polymer-dispersed ultraviolet curable resin composition and reducing interfacial tension.

The thickness of the skin layer 3 is defined in a range of not less than 1 μm and not more than 10 μm because, when thinner than 1 μm, a portion of the conductor 2 is likely to be exposed and unevenness in wettability are likely to occur. On the other hand, a low-dielectric effect of the thin porous layer is undermined when the skin layer 3 is thicker than 10 μm.

The viscosity B of the ultraviolet curable resin composition used for the skin layer 3 is higher than the viscosity A of the hydrous water absorbent polymer-dispersed ultraviolet curable resin composition used for the porous layer 4 in order to suppress mixing of materials especially for simultaneous coating to form a stable two-layer structure.

The porosity of the porous layer 4 is determined to be not less than 50% and not more than 70% since problems, such that an effect of a low-dielectric porous layer is reduced when the porosity is lower than 50% and dispersion of the hydrous water absorbent polymer is likely to be unstable and the coating quality also decreases when higher than 70%, are likely to occur.

Structure of Coaxial Cable

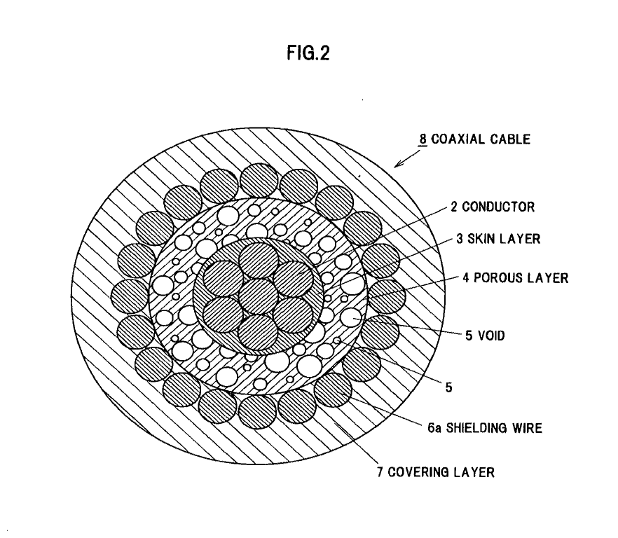

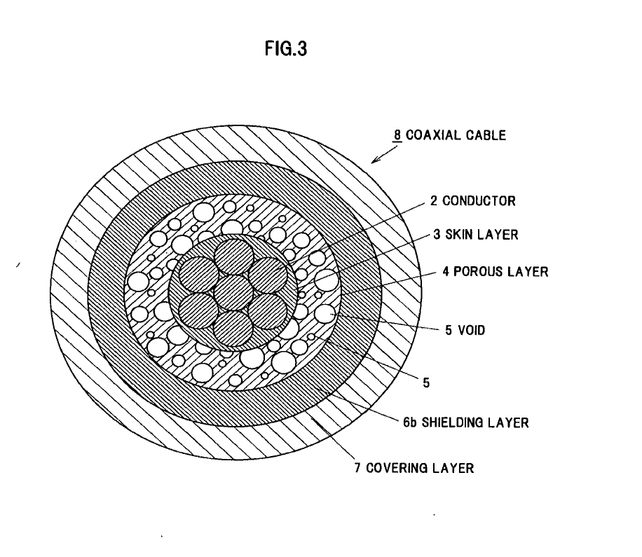

One example of a coaxial cable 8 is schematically shown in FIGS. 2 and 3. In these drawing, members substantially the same as those of the above-mentioned coated wire 1 are denoted by the same component names and reference numerals. For obtaining the coaxial cable 8, a shielding wire 6a as a metal shield body is formed to cover an outer periphery of the coated wire 1 and a covering layer 7 is formed to cover an outer periphery of the shielding wire 6a, as shown in FIG. 2. Another example of the coaxial cable 8 may be a coaxial cable 8 shown in FIG. 3 in which a shielding layer 6b as a shield body formed of metal-including synthetic resin is formed to cover an outer periphery of the porous layer 4 instead of forming the shielding wire 6a and the covering layer 7 is formed to cover an outer periphery of the shielding layer 6b.

Hydrous Water Absorbent Polymer-Dispersed Ultraviolet Curable Resin Composition

Here, a hydrous water absorbent polymer-dispersed ultraviolet curable resin composition used for a coated wire and a cable as Configured above will be described below. The hydrous water absorbent polymer-dispersed ultraviolet curable resin composition is prepared such that a hydrous water absorbent polymer prepared by swelling a water absorbent polymer with water is dispersed into an ultraviolet curable resin composition so as to have a water content of 40% or more.

A water absorbent polymer is a macromolecular substance which absorbs water very well and does not release the absorbed water due to its high water-holding ability even if some pressure is applied, and a hydrous water absorbent polymer is a water absorbent polymer having water absorbed therein. A water absorbent polymer, which does not contain sodium and of which an amount of water absorption is 20 g/g or more, is preferable. A typical water absorbent polymer includes polyalkylene oxide-based resin.

Sodium is not contained since it tends to cause a decrease in electrical insulation. The amount of water absorption is an amount of water (g) absorbed per 1 g of water absorbent polymer. The amount of water absorption is determined to be 20 g/g or more since void formation efficiency is reduced when the amount of water absorption is smaller than 20 g/g and it is necessary to use more water absorbent polymer.

Dielectric Constant

As an ultraviolet curable resin composition, it is possible to select various resin compositions such as urethane-based, silicone-based, fluorine-based, epoxy-based, polyester-based and polycarbonate-based resin compositions as long as it is curable by ultraviolet light, and the preferred dielectric constant of the resin composition is 4 or less, and preferably 3 or less.

Alternatively, a hydrous water absorbent polymer-dispersed ultraviolet curable resin composition doped with a dispersant, a leveling agent, a coupling agent, a colorant, a flame retardant, an antioxidant, an electrical insulation improver and a filler, etc., may be used even though it is not specifically limited thereto.

Water Content

The water content of the hydrous water absorbent polymer-dispersed ultraviolet curable resin composition is adjusted to 40% or more since the hydrous water absorbent polymer less affects a decrease in wettability with a metal wire when lower than 40% and a stable porous coating layer can be formed without providing the skin layer 3. Here, the water content is a percentage of water contained in the hydrous water absorbent polymer-dispersed ultraviolet curable resin composition having a hydrous water absorbent polymer dispersed therein.

Method of Manufacturing a Coaxial Cable

The coated wire 1 as configured above is manufactured through the following processes.

(1) A process of preparing an ultraviolet curable resin composition as well as preparing a hydrous water absorbent polymer-dispersed ultraviolet curable resin composition having a water content of 40% or more by dispersing into the ultraviolet curable resin composition a hydrous water absorbent polymer prepared by swelling a water absorbent polymer with water in advance.

(2) A process of coating the outer periphery of the conductor 2 with the ultraviolet curable resin composition not including the hydrous water absorbent polymer and the hydrous water absorbent polymer-dispersed ultraviolet curable resin composition in accordance with the usual method to form a two-layer structure and subsequently performing dehydration by heating on the two-layer structure.

It is preferable to use microwave heating in order to thermally dehydrate the water absorbed in the water absorbent polymer. The reason for using microwave heating is that, since the water is rapidly heated by microwave, it is possible to perform thermal dehydration in a short time without affecting the water absorbent polymer and surrounding resin, etc., and the void 5 can be efficiently formed. Use of a waveguide microwave heating furnace allows continuous thermal dehydration. For this heating, a waveguide microwave heating furnace may be used in combination with a conventional heating furnace.

In addition, the reason for thermal dehydration after cross link curing is that it is possible to prevent a decrease in porosity due to volume contraction by dehydration as well as variation in film thickness or outer diameter, and a stable wire or cable can be thereby obtained. Furthermore, since the porous layer 4 in which a portion to be the void 5 is preliminarily included can be formed, it is not necessary to foam and it is possible to obtain a stable coated wire or coaxial cable without any decrease in adhesion due to expansion or separation between the skin layer 3 and the porous layer 4 which is likely to occur in conventional gas foaming by gas injection or foaming agents. A coaxial cable is manufactured by coating an outer periphery of the coated wire with a shield body as described above, and it is obvious that the same effect as the coated wire is obtained.

### EXAMPLES

The porous ultraviolet curable resin coated wire as a further specific embodiment of the invention will be illustrated below by Examples and Comparative Example.

Resin Composition A

The following Table 1 shows an example of resin composition A exemplified as ultraviolet curable resin compositions of Examples 1-3 and Comparative Example 1.

A film having a thickness of about 200 μm was made by using a 15 MIL blade and curing the resin composition A on a glass plate at a UV dose of 500 mJ/cm² in a nitrogen atmosphere. The dielectric constant of the film formed of the resin composition A obtained by a cavity resonance method was 2.70 at a frequency of 10 GHz. The viscosity measurement results of the film were 4500 mPa·s at 25° C., 2100 mPa·s at 40° C., 1000 mPa·s at 60° C. and 450 mPa·s at 80° C.

TABLE 1

| Composition/Viscosity | | Resin composition A |
|---|---|---|
| Urethane acrylate oligomer*¹ | | 65 parts by mass |
| Dicyclopentanyl diacrylate*² | | 5 parts by mass |
| Dicyclopentanyl acrylate*³ | | 15 parts by mass |
| N-vinylpyrrolidone*⁴ | | 15 parts by mass |
| 2,4,6-trimethylbenzoyl diphenyl phosphine oxide*⁵ | | 3 parts by mass |
| 1-hydroxycyclohexyl phenyl ketone*⁶ | | 2 parts by mass |
| Dielectric constant of cured substance | | 2.70 |
| (cavity resonance method at 10 GHz) | | |
| Viscosity (mPa · s) | 25° C. | 4500 |
| | 40° C. | 2100 |
| | 60° C. | 1000 |
| | 80° C. | 450 |

*¹UA-4002HM manufactured by Shin-Nakamura Chemicals Co., Ltd.,
*²R-684 manufactured by NIPPON KAYAKU Co., Ltd.,
*³FA-513AS manufactured by Hitachi Chemical Co., Ltd.,
*⁴Wako Pure Chemical Industries, Ltd.,
*⁵DAROCUR TPO manufactured by Ciba Specialty Chemicals,
*⁶IRGACURE 184 manufactured by Ciba Specialty Chemicals

Resin Composition B

For forming the hydrous water absorbent polymer, after a water absorbent polymer “AQUACALK TWP-PF (manufactured by Sumitomo Seika Chemicals Co., Ltd.)” having an average particle size of 50 μm and distilled water were mixed at the ratio of 1:31 and left 24 hours, a high-pressure homogenizer (PANDA 2K TYPE manufactured by Niro Soavi Inc.) was used. A process of dispersing the hydrous water absorbent polymer was performed once at a pressure of 130 MPa.

The hydrous water absorbent polymer-dispersed ultraviolet curable resin composition was prepared as the resin composition B by adding this hydrous water absorbent polymer to the ultraviolet curable resin composition so as to have a water content of 50%, and stirring and dispersing at a revolution of 600 rpm for 30 minutes while heating to 50° C.

### Example 1

The resin composition A heated to 40° C. so as to have a viscosity of 2000 mPa·s was used to form a 10 μm-thick inner layer (skin layer) and the resin composition B heated to 50° C. so as to have a viscosity of 1000 mPa·s was used to form a 100 μm-thick outer layer (porous layer). The inner and outer layers were simultaneously applied on a twisted conductor 40 AWG (7/0.03 GAH-NN) in a pressure coating tank at a velocity of 50 m/min and were cured by passing through an ultraviolet irradiator with 2 lamps (6 kW, manufactured by EYE GRAPHICS CO., LTD), and then, thermal dehydration was performed in a drying furnace at 60° C. for 24 hours, and the porous ultraviolet curable resin coated wire was thereby obtained.

### Example 2

The resin composition A heated to 40° C. so as to have a viscosity of 2000 mPa·s was used to form a 2 μm-thick inner layer and the resin composition B heated to 50° C. so as to have a viscosity of 1000 mPa·s was used to form a 110 μm-thick outer layer. The inner and outer layers were simultaneously applied on a twisted conductor 40 AWG (7/0.03 GAH-NN) in a pressure coating tank at a velocity of 50 m/min and were cured by passing through an ultraviolet irradiator with 2 lamps (6 kW, manufactured by EYE GRAPHICS CO., LTD), and then, thermal dehydration was performed in a drying furnace at 60° C. for 24 hours, and the porous ultraviolet curable resin coated wire was thereby obtained.

### Example 3

The resin composition A heated to 40° C. so as to have a viscosity of 2000 mPa·s was used to form an inner layer having a film thickness of less than 1 μm and the resin composition B heated to 50° C. so as to have a viscosity of 1000 mPa·s was used to form a 110 μm-thick outer layer. The inner and outer layers were simultaneously applied on a twisted conductor 40 AWG (7/0.03 GAH-NN) in a pressure coating tank at a velocity of 50 m/min and were cured by passing through an ultraviolet irradiator with 2 lamps (6 kW, manufactured by EYE GRAPHICS CO., LTD), and then, thermal dehydration was performed in a drying furnace at 60° C. for 24 hours, and the porous ultraviolet curable resin coated wire was thereby obtained.

### Comparative Example 1

The resin composition B heated to 50° C. so as to have a viscosity of 1000 mPa·s was used to form a 110 μm-thick outer layer, without coating the resin composition A. The outer layer was applied on a twisted conductor 40 AWG (7/0.03 GAH-NN) in a pressure coating tank at a velocity of 50 m/min and were cured by passing through an ultraviolet irradiator with 2 lamps (6 kW, manufactured by EYE GRAPHICS CO., LTD), and then, thermal dehydration was performed in a drying furnace at 60° C. for 24 hours, and the porous ultraviolet curable resin coated wire was thereby obtained.

Evaluation Results

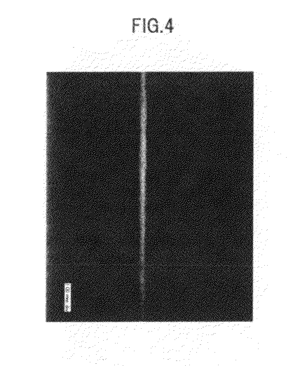

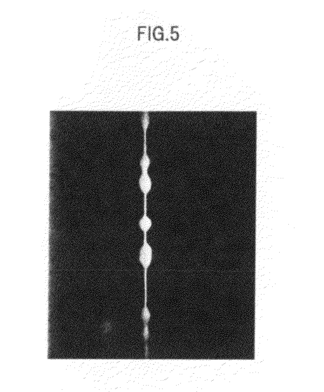

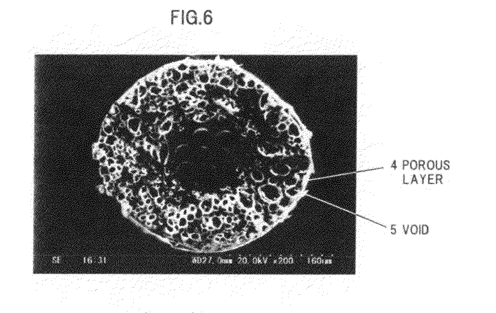

The following Table 2 shows all results of outer diameter variation of the porous ultraviolet curable resin coated wires of the above-mentioned Examples 1-3 and Comparative Example 1. The external appearance of the coated wires in the above-mentioned Examples 1-3 are shown in FIGS. 4 and 6, and the external appearance of the coated wire in Comparative Example 1 is shown in FIG. 5.

TABLE 2

| | | | | Comparative |
|---|---|---|---|---|
| | Examples | | | Example |
| | 1 | 2 | 3 | 1 |
| Conductor diameter (mm) | 0.9 | 0.9 | 0.9 | 0.9 |
| Thickness of Skin layer (μm) | 10 | 2 | <1 | — |
| Thickness of Porous layer (μm) | 100 | 110 | 110 | 110 |
| Outer diameter variation (μm) | ±10 | ±15 | ±50 | 100< |

As is obvious from Table 2 and FIG. 4, it is understood that, in the porous ultraviolet curable resin coated wires of Examples 1-3, a stable coated wire with small outer diameter variation can be obtained by providing a skin layer (inner layer). Meanwhile, from the comparison between Examples 2 and 3 shown in Table 2, it is understood that the outer diameter variation in a longitudinal direction is small when the skin layer is thicker than 1 μm. As is obvious from FIG. 6, it is understood that mixing of materials can be suppressed and a stable two-layer structure can be formed.

As can be understood from Table 2 and FIG. 5, the porous ultraviolet curable resin coated wire in Comparative Example 1 is a non-uniform coated wire in which the outer diameter variation in a longitudinal direction is large and the coating quality significantly decreases.

As is obvious from the above-mentioned description, the above-mentioned embodiment and Examples give a typical example of the porous ultraviolet curable resin coated wire and the invention is not specifically limited to these embodiment and Examples. It is obvious that the invention is efficiently applicable to a coaxial cable manufactured by coating an outer periphery of a porous ultraviolet curable resin coated wire with a shield body and a coating layer, and various design variations can be made within the scope of the matters described in each claim.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A method of manufacturing a porous ultraviolet curable resin coated wire, comprising:
preparing an ultraviolet curable resin composition not including a hydrous water absorbent polymer;
preparing a hydrous water absorbent polymer-dispersed ultraviolet curable resin composition having a water content of 40% or more by preparing a water-swollen hydrous water absorbent polymer comprising a water absorbent polymer and water, and then dispersing the hydrous water absorbent polymer into the ultraviolet curable resin composition;
forming a two-layer structure on a metal wire by coating the metal wire with the ultraviolet curable resin composition not including the hydrous water absorbent polymer and the hydrous water absorbent polymer-dispersed ultraviolet curable resin composition; and
performing a dehydration on the two-layer structure.

2. The method according to claim 1, wherein
the two-layer structure is formed by coating and curing the ultraviolet curable resin composition not including the hydrous water absorbent polymer on the metal wire, and then coating the hydrous water absorbent polymer-dispersed ultraviolet curable resin composition on the ultraviolet curable resin composition.

3. The method according to claim 1, wherein
the two-layer structure is formed by simultaneously coating on the metal wire the ultraviolet curable resin composition not including the hydrous water absorbent polymer and the hydrous water absorbent polymer-dispersed ultraviolet curable resin composition.

4. The method according to claim 1, wherein
a relation of A<B is established where A represents a viscosity of the hydrous water absorbent polymer-dispersed ultraviolet curable resin composition and B represents a viscosity of the ultraviolet curable resin composition not including the hydrous water absorbent polymer.

5. A porous ultraviolet curable resin coated wire, comprising:
a metal wire;
a skin layer on the metal wire; and
a porous layer on the skin layer,
wherein the skin layer comprises an ultraviolet curable resin composition not including a hydrous water absorbent polymer, and
the porous layer comprises a hydrous water absorbent polymer-dispersed ultraviolet curable resin composition having a water content of 40% or more formed by preparing a water-swollen hydrous water absorbent polymer comprising a water absorbent polymer and water, and then dispersing the hydrous water absorbent polymer into the ultraviolet curable resin composition.

6. The porous ultraviolet curable resin coated wire according to claim 5, wherein
the porous layer comprises a porous ultraviolet curable resin that is obtained by curing the hydrous water absorbent polymer-dispersed ultraviolet curable resin composition and then performing a thermal dehydration on the hydrous water absorbent polymer-dispersed ultraviolet curable resin composition.

7. The porous ultraviolet curable resin coated wire according to claim 5, wherein
the skin layer has a thickness of not less than 1 μm and not more than 10 μm.

8. A coaxial cable, comprising:
the porous ultraviolet curable resin coated wire according to claim 5; and
a shielding body comprising a metal and formed on outer periphery of the porous ultraviolet curable resin coated wire.
